(19) United States
(12) Patent Application Publication
(10) Pub. No.: US 2020/0033614 A1
(43) Pub. Date: Jan. 30, 2020

(54) DISPLAY APPARATUS AND ON-VEHICLE HEAD-UP DISPLAY SYSTEM

(71) Applicant: BOE Technology Group Co., Ltd., Beijing (CN)

(72) Inventor: Bingchuan SHI, Beijing (CN)

(73) Assignee: BOE Technology Group Co., Ltd.

(21) Appl. No.: 16/454,190

(22) Filed: Jun. 27, 2019

(30) Foreign Application Priority Data
Jul. 26, 2018 (CN) 201810835364.X

(51) Int. Cl. G02B 27/22; G02B 27/01; G02B 27/28; G02B 27/30; G02B 17/00

(52) U.S. Cl. CPC G02B 27/225; G02B 27/2235; G02B 27/0101; G02B 27/286; G02B 2027/011; G02B 17/002; G02B 2027/0134; G02B 2027/0123; G02B 2027/014; G02B 27/30

(57) ABSTRACT

The disclosure discloses a display apparatus and an on-vehicle head-up display system. The display apparatus comprises two imaging devices apart by a set distance, an optical splitter, and a reflector; wherein the two imaging devices are configured to display a left eye image and a right eye image respectively; the optical splitter is configured to receive and transmit emergent light of the two imaging devices to the reflector and to reflect reflected light of the reflector to set positions, wherein the set positions are symmetric with exit pupil positions of the two imaging devices with respect to a light splitting surface of the optical splitter; and the reflector is configured to reflect incident light back along its incident path.

### CROSS-REFERENCE TO RELATED APPLICATION

This application claims priority to Chinese Patent Application No. 201810835364.X, filed on Jul. 26, 2018, the content of which is incorporated by reference in the entirety.

### FIELD

This disclosure relates to the field of display technologies, and in some embodiments to a display apparatus and an on-vehicle head-up display system.

### DESCRIPTION OF THE RELATED ART

As an emerging display technology in recent years, the virtual reality (VR) technology is a technology that uses a computer to simulate the real world and thereby enables a participant to integrate into and interact with the virtual environment. The VR display technology in the related art shall combine an optical system for imaging to thereby display a special display effect, and a lens or a lens assembly is generally integrated into a display device for optical imaging. A viewer views different signal sources with the left eye and the right eye respectively through optical components such as a lens, and the brain integrates pictures viewed from the left and right eyes to obtain a stereoscopic picture.

### SUMMARY

Embodiments of the disclosure provides a display apparatus and an on-vehicle head-up display system.

In an aspect, the embodiments of the disclosure provide a display apparatus, including: two imaging devices apart by a set distance, an optical splitter, and a reflector; where the two imaging devices are configured to display a left eye image and a right eye image respectively; the optical splitter is configured to receive and transmit emergent light of the two imaging devices to the reflector and to reflect reflected light of the reflector to set positions, where the set positions are symmetric with exit pupil positions of the two imaging devices with respect to a light splitting surface of the optical splitter; and the reflector is configured to reflect incident light back along its incident path.

In some embodiments, each of the two imaging devices includes an image display component and a collimating lens; the image display component is configured to display a display image composed of a plurality of display elements; and the collimating lens is configured to collimate emergent light of the plurality of display elements respectively.

In some embodiments, the image display component includes an illumination sub-component and an image generation sub-component; the illumination sub-component is configured to emit illumination rays to the image generation sub-component; and the image generation sub-component is configured to modulate the illumination rays to generate the display image.

In some embodiments, the illumination sub-component includes: a light source, and a collimating lens and a light homogenization device arranged in sequence in a light emitting direction of the light source.

In some embodiments, the light homogenization device includes a light tube or a micro-lens array.

In some embodiments, the image generation sub-component includes a liquid crystal display panel, a liquid crystal on silicon display panel, or a digital micro-mirror array.

In some embodiments, the image display component includes an organic light emitting diode display panel.

In some embodiments, the optical splitter includes a transparent substrate and a medium film at one side surface of the transparent substrate for adjusting a reflectivity of the optical splitter.

In some embodiments, the optical splitter includes a linear polarization layer and a λ/4 phase retardation layer arranged in a light exiting direction of the two imaging devices; and an angle between a polarization direction of the linear polarization layer and an optical axis of the λ/4 phase retardation layer is 45°.

In some embodiments, the reflector includes a micro-pyramid prism plate.

In some embodiments, an angle between light incident on an incident surface of the micro-pyramid prism plate and a normal of the incident surface is less than or equal to 35°.

In some embodiments, a diameter of an exit pupil of each of the two imaging devices is greater than 50 mm.

In some embodiments, each of the two imaging devices further includes an image processor connected with the image display component; and the image processor is configured to perform distortion compensation on the display image.

In another aspect, the embodiments of the disclosure further provide an on-vehicle head-up display system, including the display apparatus according to the embodiments of the disclosure; where the two imaging devices are at a position proximate to a visor, the optical splitter is at an inner side of a windshield, and the reflector is on a dashboard.

In some embodiments, each of the two imaging devices includes an image display component and a collimating lens; the image display component is configured to display a display image composed of a plurality of display elements; and the collimating lens is configured to collimate emergent light of the plurality of display elements respectively.

In some embodiments, the image display component includes an illumination sub-component and an image generation sub-component; the illumination sub-component is configured to emit illumination rays to the image generation sub-component; and the image generation sub-component is configured to modulate the illumination rays to generate the display image.

In some embodiments, the optical splitter includes a transparent substrate and a medium film at one side surface of the transparent substrate for adjusting a reflectivity of the optical splitter.

In some embodiments, the optical splitter includes a linear polarization layer and a λ/4 phase retardation layer arranged in a light exiting direction of the two imaging devices; and an angle between a polarization direction of the linear polarization layer and an optical axis of the λ/4 phase retardation layer is 45°.

In some embodiments, the reflector includes a micro-pyramid prism plate.

In some embodiments, a diameter of an exit pupil of each of the two imaging devices is greater than 50 mm.

### BRIEF DESCRIPTION OF THE DRAWINGS

In order to make the technical solutions according to the embodiments of the disclosure more apparent, the drawings to which a description of the embodiments refers will be briefly introduced below, and apparently the drawings to be described below are merely illustrative of some of the embodiments of the disclosure, and those ordinarily skilled in the art can derive from these drawings other drawings without any inventive effort.

FIG. 1 is a schematic structural diagram of a display apparatus according to the embodiments of the disclosure.

FIG. 2 is a first schematic structural diagram of an imaging device according to the embodiments of the disclosure.

FIG. 3 is a second schematic structural diagram of an imaging device according to the embodiments of the disclosure.

FIG. 4 is an optical path schematic diagram of a collimating lens according to the embodiments of the disclosure.

FIG. 5A is a first schematic structural diagram of an optical splitter according to the embodiments of the disclosure.

FIG. 5B is a second schematic structural diagram of an optical splitter according to the embodiments of the disclosure.

FIG. 6A is a top view of a structure of a micro-pyramid prism plate according to the embodiments of the disclosure.

FIG. 6B is a sectional view of a structure of a micro-pyramid prism plate according to the embodiments of the disclosure.

FIG. 6C is a schematic structural diagram of a single micro-pyramid prism according to the embodiments of the disclosure.

FIG. 7 is a sectional view of a structure of a single micro-pyramid prism according to the embodiments of the disclosure.

FIG. 8 is a third schematic structural diagram of an imaging device according to the embodiments of the disclosure.

### DETAILED DESCRIPTION OF THE EMBODIMENTS

As a near-eye display technology, the VR display technology can provide a viewer with a virtual-image display effect having a large angle of view and a high definition. However, the viewer needs to wear a display device such as glasses, a helmet and the like, and the display image can only be viewed when the eyes get close to the display device. In spite of many advantages, the VR display technology in the related art still cannot be applied to application fields such as an on-vehicle display field, due to failing to get rid of the limitations of wearing equipment.

Embodiments of the disclosure provide a display apparatus and an on-vehicle head-up display system, so as to enlarge an exit pupil distance of the display system and make it adapt to more application fields.

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

The display apparatus and the on-vehicle head-up display system according to the embodiments of the disclosure will be described below in details with reference to the drawings.

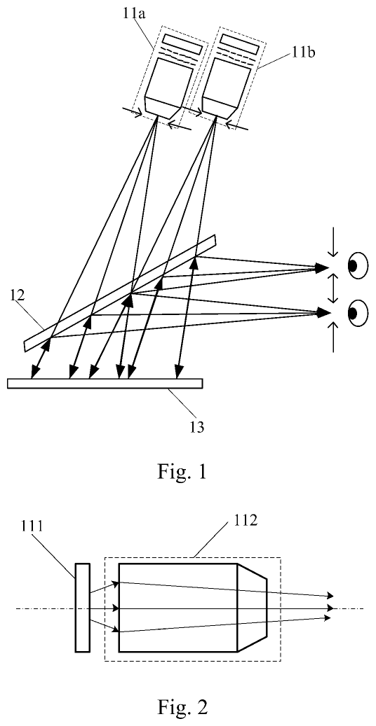

As illustrated in FIG. 1, the display apparatus according to the embodiments of the disclosure includes: two imaging devices 11a and 11b apart by a set distance, an optical splitter 12, and a reflector 13; where the two imaging devices are configured to display a left eye image and a right eye image respectively; for example, the imaging device 11a is configured to display the right eye image, and the imaging device 11b is configured to display the left eye image. The optical splitter 12 is configured to receive and transmit emergent light of the two imaging devices to the reflector 13, and to reflect reflected light of the reflector 13 to set positions, where the set positions are symmetric with exit pupil positions of the two imaging devices with respect to a light splitting surface of the optical splitter 12; and the reflector 13 is configured to reflect incident light back along its incident path. Where the light splitting surface of the optical splitter 12 is generally a planar surface or a substantially planar surface, for splitting light, of the optical splitter 12.

As illustrated in FIG. 1, after the emergent light of an imaging device passes through the optical splitter 12, a part of light is transmitted to the reflector 13, and the other part of light is reflected back to a position where the imaging device is located. For the part of light transmitted to the reflector 13, the reflector 13 reflects the incident light back along its incident path to the optical splitter 12, and the optical splitter 12 reflects a part of the light to a set position and the other part of the light back to the reflector. The optical splitter and the reflector, combined with each other, can reflect the part of light, passing through the optical splitter, of the imaging devices to the set positions where eyes of a viewer are located, where the set positions can be equivalent to the exit pupil positions of the imaging devices on an optical path, and the set positions are symmetric with the exit pupil positions of the imaging devices with respect to the light splitting surface of the optical splitter. Thus, the effect of the image viewed at the set positions and the effect of the image viewed at the exit pupil positions of the imaging devices are the same, so that the viewer can view the display image of the imaging devices at the symmetric set positions without the need to approach the exit pupil positions of the imaging devices.

In the display apparatus according to the embodiments of the disclosure, the two imaging devices 11a and 11b adopt the binocular stereo vision principle for displaying the left eye image and the right eye image, respectively. The parameters of the right-eye imaging device 11a and the left-eye imaging device 11b are the same; for example, the imaging lenses used in the right-eye imaging device 11a and the left-eye imaging device 11b are identical, and the type of the lenses, the number of the lenses, and the focal lengths and curvatures of the lenses used in the imaging lenses are all the same. When the right eye image and the left eye image are respectively displayed by such imaging devices, the display image of the right-eye imaging device 11a is received by the right eye of the viewer and the display image of the left-eye imaging device 11b is received by the left eye of the viewer, respectively; and then the left eye image and the right eye image can be integrated into a stereo image in the viewer's brain. The imaging devices can be set under the principle of a virtual reality/augmented reality display system, thus also have characteristics of a large angle of view and high-definition imaging. The right-eye imaging device 11a and the left-eye imaging device 11b are arranged apart from each other by a certain distance that shall match with a pupil distance between the left and right eyes of a human being. That is, the distance between the two imaging devices is set to be substantially equal to the pupil distance between the left and right eyes of the human being, for example, a typical value of the distance can be 66 mm; and of course, in a practical application, the distance can be slightly adjusted according to an actually required pupil distance.

In the display apparatus according to the embodiments of the disclosure, by arranging an optical splitter and a reflector, the light emitted from the imaging devices is firstly incident on the reflector after passing through the optical splitter, then reflected back along its incident path to the optical splitter by the reflector, and finally reflected to the two eyes by the optical splitter, thus the display apparatus can form new exit pupils at positions symmetric with the exit pupil positions of the imaging devices with respect to the light splitting surface of the optical splitter, and thereby the display image viewed by the viewer at the new exit pupil positions is identical with the display image viewed by approaching the exit pupil positions of the imaging devices, so that the viewer can view the image displayed by the imaging devices without the need to approach the imaging devices. In this way, the display apparatus may be provided with an enlarged exit pupil distance, and may no longer need support from carriers, such as glasses, helmets and the like, and thereby is suitable to more application scenarios such as an on-vehicle display or the like.

In some embodiments, in the display apparatus according to the embodiments of the disclosure, as illustrated in FIG. 2, each imaging device includes: an image display component 111 and a collimating lens 112; where, the image display component 111 is configured to display a display image composed of a plurality of display elements, and the collimating lens 112 is configured to collimate emergent light of respective display elements, respectively.

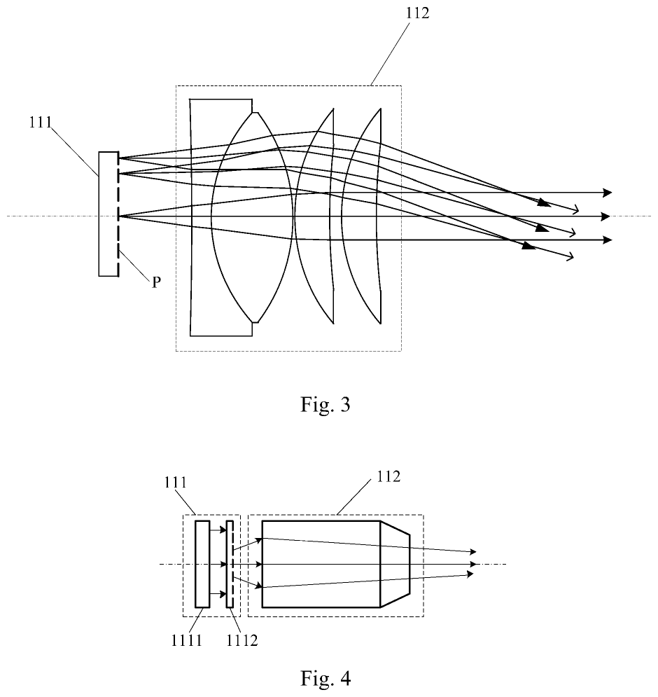

The display image of the image display component 111 is composed of a plurality of display elements, and the display elements can be understood as pixel units; and the emergent light of each pixel unit generally has a certain divergence angle. The function of the collimating lens 112 is to collimate emergent beams of each display element as parallel beams of a specific angle, thereby imaging the display image at infinity. FIG. 3 is an optical path principle diagram of a collimating lens; where the collimating lens is generally a lens assembly, and emergent beams of a display element P of the image display component 11 can be collimated as parallel beams under the function of the collimating lens. For emergent beams of each display element P, the collimating lens has a function of collimating the emergent beams of the display element P as parallel beams, but angles of parallel beams formed by respective display elements are not necessarily the same, and the parallel beams may image the display image of the image display component at infinity. Thus, when the parallel beams are converged at a system exit pupil under the functions of the reflector and the optical splitter, the viewer can view the display image of the image display component 111 at a position of the system exit pupil clearly. The collimating lens collimates the emergent beams of the display elements into parallel beams, and the beams are kept at a collimated state before reaching the system exit pupil, with no aberration introduced, therefore, what observed by the viewer at the system exit pupil is equivalent to what observed at the exit pupil of the collimating lens, thus, when the collimating lens has a large angle of view, the system exit pupil may also have the same angle of view.

In some embodiments, in the imaging device above according to the embodiments of the disclosure, as illustrated in FIG. 4, the image display component 111 includes an illumination sub-component 1111 and an image generation sub-component 1112; where the illumination sub-component 1111 is configured to emit illumination rays to the image generation sub-component 1112; and the image generation sub-component 1112 is configured to modulate the illumination rays so as to generate an display image.

When the image generation sub-component 1112 needs to cooperate with the illumination sub-component 1111 to display an image, the image generation sub-component 1112 is a non-self-illuminating display device. For example, the image generation sub-component can be a two-dimensional matrix display device, which can modulate the backlight to realize brightness adjustment of different regions, thereby realizing different image display.

In some embodiments, the illumination sub-component 1111 can include: a light source, and a collimating lens and a light homogenization device arranged in that order in a light emitting direction of the light source. The light source generally includes a high-brightness light emitting diode (LED), a halogen lamp, or a cold cathode fluorescent light source, etc. The collimating lens can suppress a divergence angle of the light source and improve the use efficiency of the light source; and the light homogenization device is generally composed of a light tube, a micro-lens array, and the like, and is configured to homogenize the light emitted from the light source to ensure uniformity of illumination. The image generation sub-component 1112 can be a liquid crystal display (LCD) panel, a liquid crystal on silicon (LCOS) display panel, a digital micro-mirror device (DMD), or the like. When the image display component is a self-illuminating display device, it can be an organic light-emitting diode (OLED) display panel or the like. It shall be noted that, the embodiments of the disclosure are illustrated by merely taking the above display panel or display system as examples, the setting may be made as needed during the practical implementation, and may include, but is not limited to, the types of display devices listed above. Further, different types of display panels may have different drive circuits and drive principles, and the drive circuits and drive principles are similar to those of the display panels in the related art, and thus will not be repeated herein.

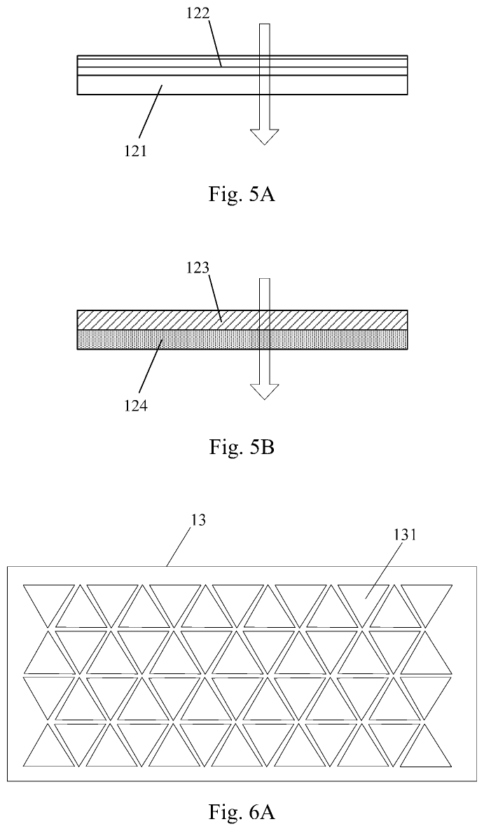

In some embodiments, in the display apparatus according to the embodiments of the disclosure, as illustrated in FIG. 5A, the optical splitter 12 at least includes: a transparent substrate 121 and a medium film 122 on any one side surface of the transparent substrate (only one of the cases is illustrated in FIG. 5A). The medium film 122 is configured to adjust a reflectivity of the optical splitter. In some embodiments, the medium film can be a metal film with a single layer or a plurality of layers, or a laminated compound medium film. For example, when a metal film is used, a material such as aluminum or silver can be used, and different transmittance and reflectivity can be realized by controlling a thickness of the metal film; when a compound medium film is used, a material such as magnesium fluoride can be used, and the refractive index can be controlled by controlling a proportion of the material of the compound, and the transmittance and reflectivity can be adjusted by controlling a thickness of the medium film. With this structure, the transmittance and reflectivity of the light can be adjusted as needed to meet actual needs. For example, in an actual application, a structure having a transmittance of 50% and a reflectivity of 50% may be used as a half transparent and half reflecting mirror, which may partially transmit the emergent light of the imaging devices; then, the transmitted light is incident on the reflector, and finally reflected to the positions where the two eyes are located after being retro-reflected by the reflector.

As can be seen from the function of the half transparent and half reflecting mirror, the half transparent and half reflecting mirror has a low efficiency in using the emergent light of the imaging devices, thus the brightness of the image that ultimately reaches the two eyes after passing through respective optical components needs to be improved. On this account, as illustrated in FIG. 5B, the optical splitter according to the embodiments of the disclosure can further include a linear polarization layer 123 and a λ/4 phase retardation layer 124 arranged in a light exiting direction of the imaging devices (a direction denoted by an arrow in FIG. 5B); where an angle between a polarization direction of the linear polarization layer 123 and an optical axis of the λ/4 phase retardation layer 124 is 45°.

When the polarization function of a circular polarizer is used to achieve the light splitting, it is beneficial to improve the utilization efficiency of the light. In some embodiments, when the image display component adopts a liquid crystal display device, the polarization direction of the linear polarization layer 123 can be set to be in parallel with a polarization direction of the emergent light of the liquid crystal display device. After the light passing through the collimating lens is incident on the linear polarization layer 123, the light is converted into a linearly polarized light whose polarization direction is parallel to the polarization direction of the linear polarization layer 123; then, the linearly polarized light is converted into a circularly polarized light after the function of the λ/4 phase retardation layer 124. At this point, a rotation direction of the circularly polarized light changes after the circularly polarized light is reflected by the reflector, if the light is right-circularly polarized light before the reflection, it may become left-circularly polarized light after reflection, and if the light is left-circularly polarized light before the reflection, it may become right-circularly polarized light after reflection. The circularly polarized light whose rotation direction is changed cannot be emitted through a circular polarizer. Therefore, the light that is incident on the circular polarizer again after being reflected by the reflector cannot be transmitted but totally reflected to a set position. Thereby, the utilization efficiency of the emergent light of the image display component can be improved. Further, the λ/4 phase retardation layer 124 may have a structure, such as a λ/4 wave plate, a reactive liquid crystal layer or the like, which is not limited herein.

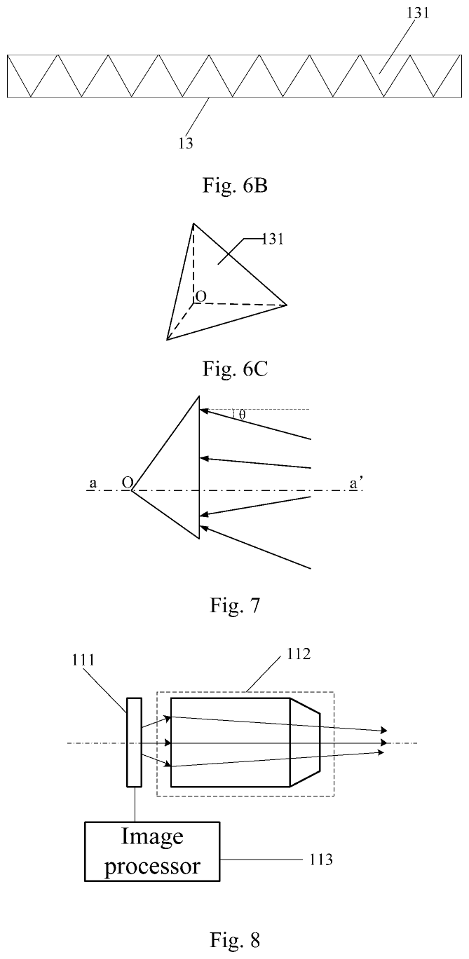

In some embodiments, in the display apparatus according to the embodiments of the disclosure, the reflector 13 can be a micro-pyramid prism plate, where the micro-pyramid prism plate can be formed by a plurality of single micro-pyramid prisms that are closely arranged, and can retro-reflect the incident light, where FIG. 6A illustrates a top view of a structure of the micro-pyramid prism plate; FIG. 6B illustrates a side view of the structure of the micro-pyramid prism plate; and FIG. 6C illustrates a structure of a single micro-pyramid prism. Where the micro-pyramid prism is of a tetrahedral structure, with only one surface not intersecting but the other three surfaces intersecting with a vertex O; and the three surfaces intersecting with the vertex O are perpendicular to each other. When the light is incident to an inside of the micro-pyramid prism from a surface that does not intersect with the vertex O, the light is sequentially reflected on the three surfaces, which are perpendicular to each other, of the micro-pyramid prism, and finally reflected out in a direction opposite to an incident direction of the light. In a practical application, the three surfaces intersecting with the vertex O can be congruent right-angled isosceles triangles, or right-angled triangles without requiring the three surfaces to be identical in shape. Since the manufacturing process of the former may be relatively easy, the structure with three reflection surfaces being congruent right-angled isosceles triangles may be adopted in practice.

In some embodiments, as illustrated in FIG. 6A and FIG. 6B, a surface that does not intersect with the vertex O shall be adopted as an incident surface of the micro-pyramid prism plate. The micro-pyramid prism plate generally has a certain available range for the incident angle. Generally, as illustrated in FIG. 7, when the light is incident on an incident surface of the micro-pyramid prism plate (the incident surface is a plane that does not intersect with the vertex O), an angle θ between the incident light and a normal aa′ of the incident surface may be less than or equal to 35°, since the angle between the emergent light of an imaging device and the optical axis of the imaging device is generally far less than 35°, even if the emergent light of the imaging device has a certain divergence angle, the angle between the beams incident on the micro-pyramid prism plate and the incident surface of the micro-pyramid prism plate may be ensured to be less than 35°.

In some embodiments, a micro-pyramid prism plate that has a large area can be fabricated by injection molding at a low cost, thus can effectively meet the demand on large-aperture beams. Further, the micro-pyramid prism plate has a corner reflection structure, and the emergent direction of the beams can be strictly ensured to be consistent with the incident direction in theory, therefore, the device itself does not introduce aberrations, and the distribution of the aberration of the original system may not be affected after adding the micro-pyramid prism plate. In addition, although the beams projected by the two imaging devices onto the micro-pyramid prism plate may overlap, however, since the micro-pyramid prism plate can reflect back the beams in all directions along their incident paths, differences in imaging properties caused by differences in positions of the beams in other common optical path systems can be prevented. Further, it shall be noted that, the reflector may adopt another optical device having the above properties, which is not limited herein.

In a practical application, the display apparatus according to the embodiments of the disclosure can have an exit pupil diameter of more than 50 mm. The exit pupil diameter of the display system depends on an exit pupil diameter of each imaging device. When the exit pupil diameter of each imaging device is greater than 50 mm, the viewer can observe the display image by moving two eyes within a range of at least 50 mm; and when the viewer needs a larger moving range, an imaging device with a larger exit pupil can be correspondingly provided, which may enable the system to have a larger visible region.

In some embodiments, as illustrated in FIG. 8, each imaging device 11 in the embodiments of the disclosure further includes an image processor 113 connected with the image display component 111; and the image processor 113 is configured to perform distortion compensation on the display image. As described above, the binocular imaging device according to the embodiments of the disclosure can adopt the display principle of a virtual reality/augmented reality display system, thus when the imaging system requires a large angle of view, the magnifications of the imaging device under different angles of view may be different, and especially distorted to a great extent in the field of view outside the axis. In this case, the image processor can be used to compensate the distortion of the display image, and then display the processed image display.

The display apparatus according to the embodiments of the disclosure can be applied to an on-vehicle head-up display system, so that the on-vehicle display can be combined with the augmented reality display, and the driver can obtain a better viewing experience in a more comfortable manner without wearing any device. In the related art, a binocular shared window optical design and a relatively large exit pupil distance are required to combine the on-vehicle display with the augmented reality display, which thereby causes difficulty in aberration correction and limits extension of the angle of view of the system which is generally within 10°; at the same time, when the angle of view of the head-up display system is increased, a more complicated optical structure and a larger-sized optical mirror are required, which may significantly increase the difficulty and cost of the manufacturing. However, the above series of problems can be prevented in the embodiments of the disclosure by applying any of the display apparatuss to the on-vehicle head-up display. In a practical implementation, the two imaging devices can be arranged proximate to a visor at a driving seat, the optical splitter can be arranged at an inner side of a windshield, and the reflector can be arranged above a dashboard. The positions of the eyes of a driver are the exit pupil positions of the display apparatus. Since the optical splitter is generally a light-transmitting component, the driver can view the display image and the road situation through the optical splitter and the windshield, so as to realize the augmented reality display effect; and the sight of the driver can switch between the driving road and the imaging of the display apparatus, which prevents visual interruption of the user while driving, thereby improves driving safety and the on-vehicle experience at the same time.

According to the display apparatus and the on-vehicle head-up display system according to the embodiments of the disclosure, the display apparatus includes two imaging devices apart by a set distance, an optical splitter, and a reflector; where the two imaging devices are configured to display a left eye image and a right eye image respectively; the optical splitter is configured to receive emergent light of respective imaging devices and to transmit the light to the reflector, and to reflect reflected light of the reflector to set positions, where the set positions are symmetric with exit pupil positions of the imaging devices with respect to a light splitting surface of the optical splitter; and the reflector is configured to reflect incident light back along its incident path. By arranging the optical splitter and the reflector, the system exit pupil distance of the display apparatus is increased, and the viewer can view the display image of the binocular imaging device at positions symmetric with the exit pupil positions of the imaging devices with respect to the light splitting surface of the optical splitter without the need to approach the exit pupil positions of the imaging devices, thus the display apparatus can be applied to a wider range of application fields, such as the on-vehicle head-up display field or the like.

Although the preferred embodiments of the disclosure have been described, those skilled in the art can make additional changes and modifications to the embodiments once they know the basic inventive concepts. Therefore, the claims are intended to be interpreted as including the preferred embodiments and the changes and modifications falling within the scope of the disclosure.

Evidently those skilled in the art can make various modifications and variations to the disclosure without departing from the spirit and scope of the disclosure. Accordingly the disclosure is also intended to encompass these modifications and variations thereto so long as the modifications and variations come into the scope of the claims appended to the disclosure and their equivalents.

1. A display apparatus, including: two imaging devices apart by a set distance, an optical splitter, and a reflector;
wherein the two imaging devices are configured to display a left eye image and a right eye image respectively;
the optical splitter is configured to receive and transmit emergent light of the two imaging devices to the reflector and to reflect reflected light of the reflector to set positions, wherein the set positions are symmetric with exit pupil positions of the two imaging devices with respect to a light splitting surface of the optical splitter; and
the reflector is configured to reflect incident light back along its incident path.

2. The display apparatus according to claim 1, wherein each of the two imaging devices comprises an image display component and a collimating lens;
the image display component is configured to display a display image composed of a plurality of display elements; and
the collimating lens is configured to collimate emergent light of the plurality of display elements respectively.

3. The display apparatus according to claim 2, wherein the image display component comprises an illumination sub-component and an image generation sub-component;
the illumination sub-component is configured to emit illumination rays to the image generation sub-component; and
the image generation sub-component is configured to modulate the illumination rays to generate the display image.

4. The display apparatus according to claim 3, wherein the illumination sub-component comprises: a light source, and a collimating lens and a light homogenization device arranged in sequence in a light emitting direction of the light source.

5. The display apparatus according to claim 4, wherein the light homogenization device comprises a light tube or a micro-lens array.

6. The display apparatus according to claim 3, wherein the image generation sub-component comprises a liquid crystal display panel, a liquid crystal on silicon display panel, or a digital micro-mirror array.

7. The display apparatus according to claim 2, wherein the image display component comprises an organic light emitting diode display panel.

8. The display apparatus according to claim 1, wherein the optical splitter comprises a transparent substrate and a medium film at one side surface of the transparent substrate for adjusting a reflectivity of the optical splitter.

9. The display apparatus according to claim 1, wherein the optical splitter comprises a linear polarization layer and a λ/4 phase retardation layer arranged in a light exiting direction of the two imaging devices; and
an angle between a polarization direction of the linear polarization layer and an optical axis of the λ/4 phase retardation layer is 45°.

10. The display apparatus according to claim 1, wherein the reflector comprises a micro-pyramid prism plate.

11. The display apparatus according to claim 10, wherein an angle between light incident on an incident surface of the micro-pyramid prism plate and a normal of the incident surface is less than or equal to 35°.

12. The display apparatus according to claim 1, wherein a diameter of an exit pupil of each of the two imaging devices is greater than 50 mm.

13. The display apparatus according to claim 2, wherein each of the two imaging devices further comprises an image processor connected with the image display component; and
the image processor is configured to perform distortion compensation on the display image.

14. An on-vehicle head-up display system, including the display apparatus according to claim 1;
wherein the two imaging devices are at a position proximate to a visor, the optical splitter is at an inner side of a windshield, and the reflector is on a dashboard.

15. The on-vehicle head-up display system according to claim 14, wherein each of the two imaging devices comprises an image display component and a collimating lens;
the image display component is configured to display a display image composed of a plurality of display elements; and
the collimating lens is configured to collimate emergent light of the plurality of display elements respectively.

16. The on-vehicle head-up display system according to claim 15, wherein the image display component comprises an illumination sub-component and an image generation sub-component;
the illumination sub-component is configured to emit illumination rays to the image generation sub-component; and
the image generation sub-component is configured to modulate the illumination rays to generate the display image.

17. The on-vehicle head-up display system according to claim 14, wherein the optical splitter comprises a transparent substrate and a medium film at one side surface of the transparent substrate for adjusting a reflectivity of the optical splitter.

18. The on-vehicle head-up display system according to claim 14, wherein the optical splitter comprises a linear polarization layer and a λ/4 phase retardation layer arranged in a light exiting direction of the two imaging devices; and
an angle between a polarization direction of the linear polarization layer and an optical axis of the λ/4 phase retardation layer is 45°.

19. The on-vehicle head-up display system according to claim 14, wherein the reflector comprises a micro-pyramid prism plate.

20. The on-vehicle head-up display system according to claim 14, wherein a diameter of an exit pupil of each of the two imaging devices is greater than 50 mm.
